(19) United States
(12) Patent Application Publication
(10) Pub. No.: US 2017/0264105 A1
(43) Pub. Date: Sep. 14, 2017

(54) METHOD AND APPARATUS FOR ELECTRIC BATTERY TEMPERATURE MAINTENANCE

(71) Applicants: Lucas STURNFIELD, Downers Grove, IL (US); Christopher Tyler, Plano, IL (US); Edward Lee Blackwell, Rochester, MN (US); Adrian Philip Glover, Houston, TX (US); Brent William Yardley, Hillsboro, OR (US)

(72) Inventors: Lucas STURNFIELD, Downers Grove, IL (US); Christopher Tyler, Plano, IL (US); Edward Lee Blackwell, Rochester, MN (US); Adrian Philip Glover, Houston, TX (US); Brent William Yardley, Hillsboro, OR (US)

(21) Appl. No.: 15/064,334

(22) Filed: Mar. 8, 2016

(51) Int. Cl. H02J 7/00

(52) U.S. Cl. CPC H02J 7/007; H02J 7/0052; H02J 7/0063; H02J 7/0021; H02J 2007/0067

(57) ABSTRACT

A method and apparatus for battery cell temperature maintenance including determining a battery cell temperature of a battery cell is below a temperature threshold and initiating a temperature maintenance mode. Upon initiation of the temperature maintenance mode, determining a charge level of the battery cell and initiating one of a charge sequence in which the battery cell is charged and a discharge sequence in which the battery cell is discharged. The charge sequence initiated upon determining the charge level is equal to or less than a discharge limit and the discharge sequence initiated upon determining the charge level is equal to or greater than a charge limit.

### BACKGROUND

Field of the Invention

The invention relates to temperature maintenance for electric batteries. More specifically, the invention relates to an electric battery method and apparatus which maintains the battery core temperature above a minimum temperature set-point via internal heating resulting from electric charge transfer activity that occurs within the battery cells during charge/discharge cycles selectively applied to the batteries.

Description of Related Art

Energy storage systems may utilize energy storage modules, for example banks of electric batteries, as the energy storage media utilized to provide on-demand electric power. A common battery chemistry is Lithium-Ion. Lithium-Ion battery cells are known to have a significantly degraded energy delivery capacity when operated while battery cell temperatures are below a “warm battery” threshold.

Where engagement of the energy storage system is a rare event, for example where the energy storage system is part of an uninterruptable power supply (UPS) solution, the electric battery, also known as the battery backup unit (BBU), may require active temperature maintenance to maintain a minimum battery cell temperature, to ensure the BBU can provide the required power levels upon demand.

Prior energy storage system electric battery temperature maintenance schemes typically utilize resistive heater elements applied proximate to the batteries and/or incorporated into the battery cell design. Heater elements have the drawback of inefficient heating of the battery cell. Heat applied external to the battery cell is also consumed by heating of the battery enclosure materials, the surrounding area and/or associated supporting hardware. Heater elements incorporated into the battery cell configuration add cost and may limit battery selection price competition available to consumers. One skilled in the art appreciates that addition of heaters may also significantly complicate the overall system requirements. Further, should any of the heaters and/or additional wiring/interconnections fail, the on-demand availability of the entire energy storage system may be jeopardized.

Competition within the electrical power storage industry has focused attention upon increasing reliability, system uptime, energy cell longevity and overall system energy and cost efficiencies.

Therefore, it is an object of the invention to provide a method and apparatus that overcomes deficiencies in such prior art.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a schematic block diagram of a battery system with battery temperature maintenance functionality, coupled to a representative energy reservoir capable of delivering energy to and drawing energy from a common rail.

FIG. 2 is a schematic flow chart of a battery temperature maintenance method.

FIG. 3 is a schematic chart of system parameters during representative system operation under the influence of continuous chilling from 5 degrees Celsius chilled air flowing over the system components at a rate of a 2-5 liter/second.

FIG. 4 is a schematic chart of system parameters during a repeated “fire hose dump” full load surge test of the representative system while internal battery cell temperature was maintained by battery temperature maintenance.

### DETAILED DESCRIPTION

The inventors have recognized that internal heating of electric battery cells occurs during charge and discharge cycles due to electric charge transfer activity across the battery electrolytic materials and surfaces. As this heating is integral to the electrolytic material at the core of the battery cell, it is highly efficient with respect to the goal of maintaining the battery cell core above a minimum temperature level known to enable efficient energy discharge from the battery cell.

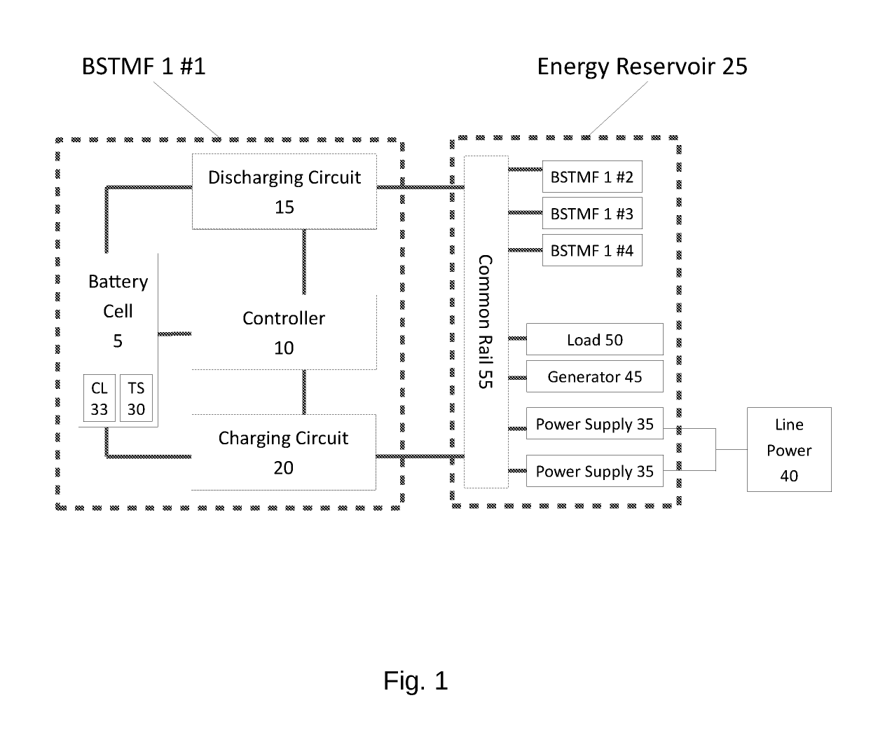

A battery system with temperature maintenance functionality (BSTMF) 1, for example as shown in FIG. 1, includes at least one battery cell 5, a controller 10, a discharging circuit 15, a charging circuit 20 and connections to an energy reservoir 25. The battery cell 5 is coupled to the controller 10, the discharging circuit 15 and the charging circuit 20, whereby the battery cell 5 may be charged and discharged under the control and feedback of the controller 10. The discharging circuit 15 and the charging circuit 20 are each coupled to the energy reservoir 25 to deliver energy from the discharging circuit 15 to the energy reservoir 25 and to receive energy from the energy reservoir 25 to energize the charging circuit 20 to charge the battery cell 5. The controller 10 may receive temperature feedback from a temperature sensor 30 of the battery cell 5, the temperature sensor 30 operable to detect a battery cell temperature of the battery cell 5. The controller 10 may also include a battery charge level detector functionality, operable to detect a charge level of the battery cell 5, for example via battery voltage interpolation. Alternatively, the battery cell 5 may include “fuel gauge” or “smart battery” circuitry operative to provide temperature sensor 30 and charge level 33 (state of charge) or the like levels/readings for individual battery cells and/or battery groups at battery cell data registers readable by the controller 10.

The battery cell 5 may be, for example, an electric battery cell with lithium-ion battery chemistry. The battery cell 5 may be comprised of a plurality of separate battery cells which are interconnected with one another in parallel and/or series to form battery groups which together store and deliver electric power at a desired voltage and current level. The temperature sensor 30 may be applied proximate a center of the battery cell(s) 5 and/or multiple temperature sensors 30 may be applied, for example one for each group of serial interconnected battery cells.

The charging and discharging circuits 20, 15 may be dynamically configurable to charge or discharge the battery cell(s) 5 individually and/or by battery groups at a desired voltage and current level. Such charge and discharge circuits are known in the art, for example as disclosed in commonly owned U.S. patent application Ser. No. 14/629,888, titled “Energy Storage System with Green Maintenance Discharge Cycle”, filed 24 Feb. 2015, hereby incorporated by reference in the entirety, and as such are not disclosed in further detail herein.

The energy reservoir 25 may be further battery cells 5 and/or battery groups, power supplies 35 fed by line power 40, power generators 45 and/or power consumers/loads 50 each coupled to a common rail 55. The additional battery cells and/or battery groups may comprise further BSTMF 1 systems (demonstrated as BSTMF 1 #2-4 with a single schematic coupling to the common rail 55) also with battery temperature maintenance functionality as described herein, enabling exchange of power between such systems while selected battery cells 5 of one BSTMF 1 is in a discharge sequence and selected battery cells 5 of the another BSTMF 1 is in a charge sequence, significantly reducing overall power consumption of the system by conserving power expended during discharge sequences, via power exchange between BSTMF 1, even if no significant load 50 demand is attached to the energy reservoir 25 while battery cell 5 temperature maintenance is being performed.

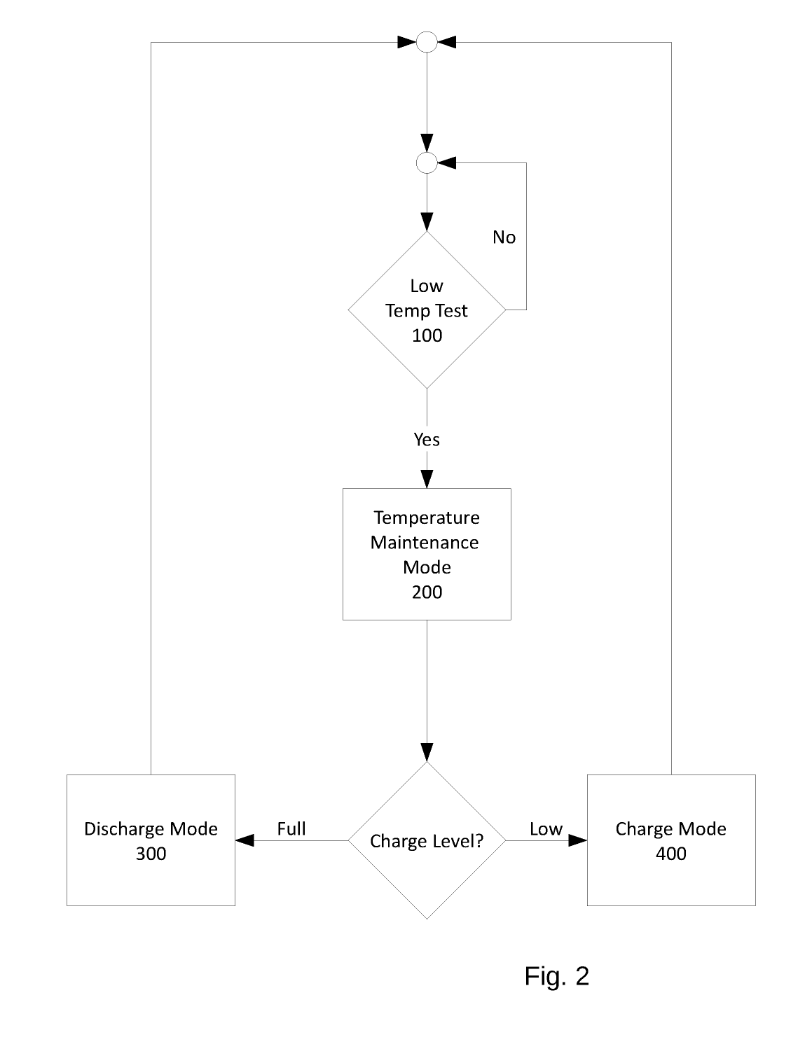

In a method for battery cell temperature maintenance, for example as shown in FIG. 2, in a battery temperature test step 100, when the controller 10 determines a battery cell temperature of a battery cell 5 is below a desired temperature threshold a temperature maintenance mode 200 may be enabled. Once the temperature maintenance mode 200 is enabled, the controller 10 determines a charge level 33 of the battery cell 5 and depending upon the charge level 33 detected will initiate either a charge sequence 300 or discharge sequence 400 for the target battery cell.

In a charge sequence 300, selected because the charge level 33 is equal to or less than a desired discharge limit, such as 70%, the target battery cell 5 is charged until the charge level 33 of the battery cell 5 rises to a desired state of charge, such as 100% of a full charge level 33 of the battery cell 5.

In a discharge sequence 400, selected because the charge level 33 is equal to or greater than a desired charge limit, such as 90-100%, the discharge is continued until the charge level of the battery cell falls to a desired partial discharge level, such as 70% or less of a full charge level of the battery cell.

Upon completion of a charge or discharge sequence 300, 400, assuming further and/or ongoing battery cell temperature maintenance is still required, the battery cell 5 will be in condition for an exchange of the sequence type, for example from a charge sequence 300 to a discharge sequence 400, enabling continuous heating of the battery cell 5 at the electrolytic core, should environmental conditions the system resides in require such.

To improve overall system power consumption efficiency and/or reduce degradation of the battery cell 5 from repeated charge and discharge sequences over extended periods of time during ongoing battery cell temperature maintenance, the charge sequence 300 may be applied at a reduced charge voltage and/or charge rate. Further, the charge voltage and/or charge rate may be selected based upon the level of battery cell temperature maintenance required, detected for example by measuring the magnitude of a differential between the battery temperature and the low temperature charge mode temperature (the differential between the current battery cell temperature and the desired battery cell temperature). For lithium-ion chemistry battery cells, the charge voltage and/or charge rate may be varied, for example, between a 3.6 to 4.35 charge voltage and a 0.2 C to 2 C charge rate. Thereby, a higher heating rate may be applied as needed, for example immediately after the system is initially revived from a cold to initialization state but a lower heating rate may then be applied during ongoing operation when only maintenance temperature heating is required for a partially “warmed” system.

Another battery cell degradation reduction procedure that may be applied is to introduce a hysteresis delay factor between charge and discharge sequences. For example, where a desired battery cell temperature of 15 degrees Celsius is desired, while the setpoint for initiating a charge sequence 300 may be 15 degrees Celsius, a discharge sequence 400 may be set to require a battery cell temperature of less than 18 degrees Celsius. Thereby, significant heating during the discharge sequence will have an additional cooling interval, allowing the battery chemistry a rest and reset period.

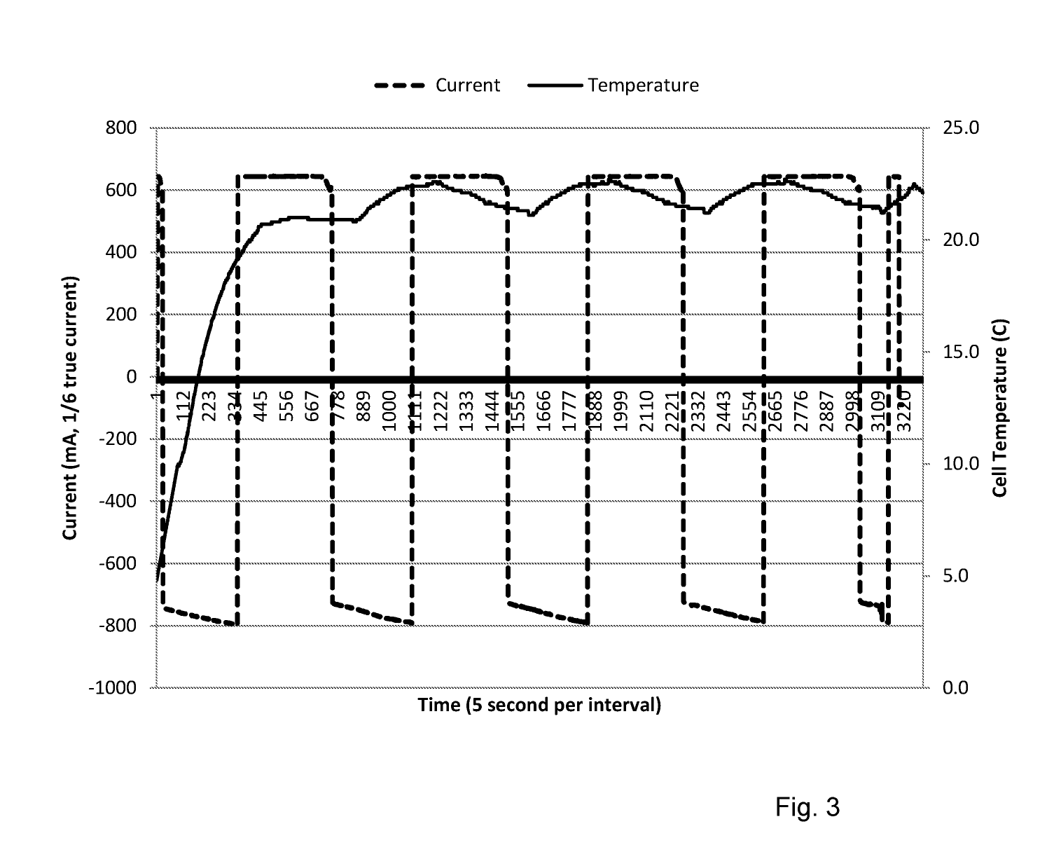

A typical electric battery chemistry is lithium-ion. The inventor's have tested lithium-ion battery cells configured in a four groups of three serial interconnected battery cell configuration, the four groups of battery cells interconnected in parallel with one another, a configuration also known as “3s4p”. The resulting collection of battery cells were then subjected to a deep cooling period at 5 degrees Celsius, via a steady stream of 5 degrees Celsius chilled air applied flowing over the assembly (2 to 5 liter/second). As shown in FIG. 3, initiation of alternating charge and discharge sequences quickly brings the battery cells core above 20 degrees Celsius, where this temperature was maintained despite the significant thermal soak of the 5 degrees Celsius chilled air moving over and past the assembly throughout the test.

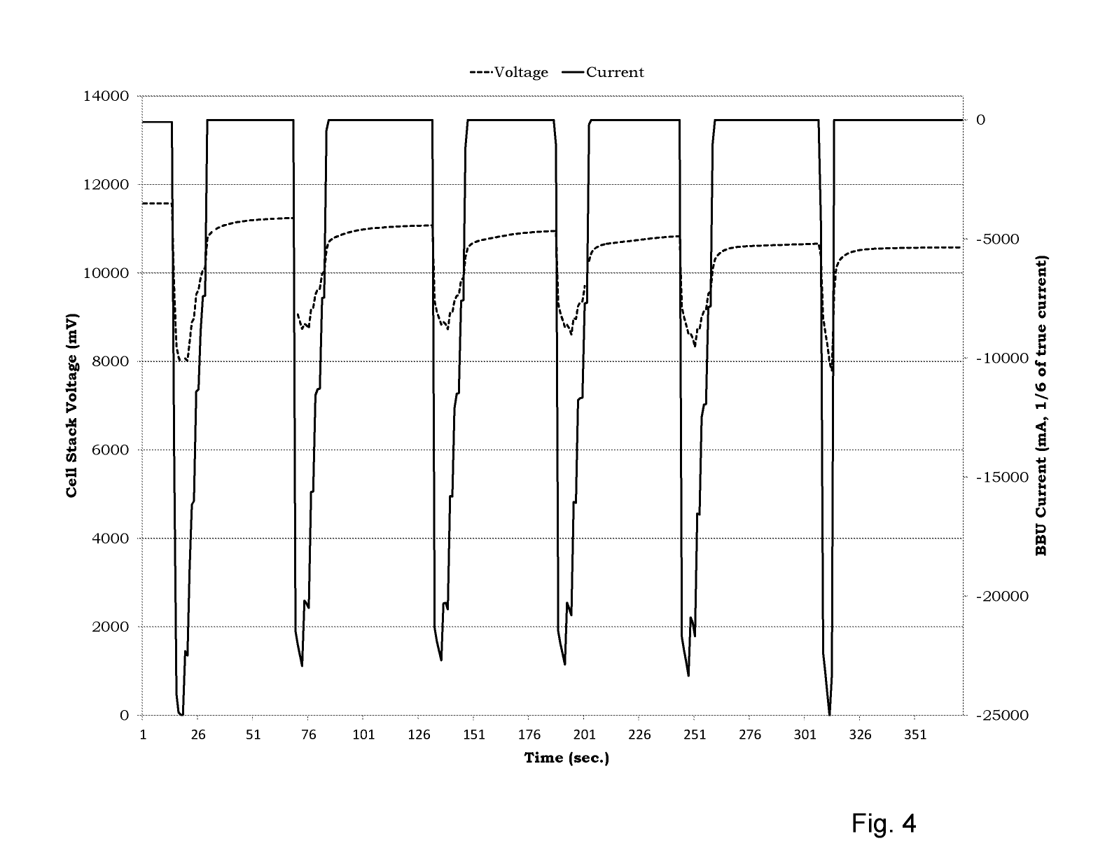

An important measure of battery cells applied as the BBU of a UPS is the ability to handle repeated instances of a near instantaneous full load current draw, also known as a “fire hose dump” (FHD), mimicking the sudden full load a UPS might be required to supply, before the UPS system software and/or operators can begin automated load reduction. When a test level of 1400 Watt FHD was applied to the 3s4p lithium-ion battery assembly while sitting at 5 degrees Celsius, ambient, the BBU was unable to provide the required 1400 Watt FHD mode, even once, demonstrating the poor low temperature power delivery characteristics of lithium-ion battery chemistry. In stark contrast, when the assembly had battery cell temperature maintenance engaged during the application of the 5 degrees Celsius chilled air (resulting in battery cell temperatures of 20-23 degrees Celsius), the assembly was able to withstand six intervals of successive 1400 Watt FHD, as shown in FIG. 4.

As the heat resulting from battery temperature maintenance is generated at the core of the battery cell, it is significantly more efficient than battery warming via external heater elements. While a conventional resistive heater element may be expected to consume approximately 3 Watts, continuously, to overcome continuous external sinking of the heat energy by the surrounding battery containment materials, adjacent equipment and/or overflowing air currents before heat applied proximate the exterior of the battery cell begins to reach the interior of the battery cell. The inventors calculate heating via charge and discharge sequences according to the claims may consume up to 8 Watts, peak, only during initial “heating” from a soaked cold state (which is also much faster ambient to operating temperature heating than can be expected from external applied heat, for the same reasons) to as little as 0.8 Watts during ongoing battery temperature maintenance, the steady state of the system—a 4 to 40 times improvement in system heating energy efficiency.

Finally, because the battery cell core heating is generated via utilization of hardware largely already present in the system for other utility, the battery temperature maintenance system may significantly simplify overall system hardware complexity, design requirements and the number of discrete components and/or interconnections required, further reducing manufacturing costs.

Table of Parts

| | |
|---|---|
| 1 | BSTMF |
| 5 | battery cell |
| 10 | controller |
| 15 | discharging circuit |
| 20 | charging circuit |
| 25 | energy reservoir |
| 30 | temperature sensor |
| 33 | charge level |
| 35 | power supply |
| 40 | line power |
| 45 | generators |
| 50 | load |
| 55 | common rail |

Where in the foregoing description reference has been made to ratios, integers or components having known equivalents then such equivalents are herein incorporated as if individually set forth.

While the present invention has been illustrated by the description of the embodiment thereof, and while the embodiment has been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

We claim:

1. A method for battery cell temperature maintenance, comprising:
determining a battery cell temperature of a battery cell is below a temperature threshold;
in response to determining the battery cell temperature is below the temperature threshold, initiating a temperature maintenance mode;
upon initiation of the temperature maintenance mode, determining a charge level of the battery cell;
in response to determining the charge level of the battery cell, initiating one of a charge sequence in which the battery cell is charged and a discharge sequence in which the battery cell is discharged;
the charge sequence initiated upon determining the charge level is equal to or less than a discharge limit;
the discharge sequence initiated upon determining the charge level is equal to or greater than a charge limit.

2. The method of claim 1, wherein the charge sequence is maintained until the charge level of the battery cell rises to a charged level.

3. The method of claim 2, wherein the charged level is 100% of a full charge level of the battery cell.

4. The method of claim 1, wherein the discharge sequence is maintained until the charge level of the battery cell falls to a partial discharge level.

5. The method of claim 4, wherein the partial discharge level is 70% or less of a full charge level of the battery cell.

6. The method of claim 1, wherein the charge sequence is applied at a charge voltage selected according to a magnitude of a differential between the battery temperature and a low temperature charge mode temperature.

7. The method of claim 1, wherein the charge sequence is applied at a charge rate selected according to a magnitude of a differential between the battery temperature and a low temperature charge mode temperature.

8. The method of claim 1, wherein the temperature maintenance mode alternates between the charge sequence and the discharge sequence until the battery temperature is no longer below the temperature threshold.

9. The method of claim 8, wherein the alternation between charge sequence and the discharge sequence includes a hysteresis delay factor.

10. The method of claim 1, wherein the battery cell is one of at least two battery cells; the at least two battery cells coupled to one another such that one battery of the at least two battery cells in the charge sequence receives electric power from another battery cell of the at least two battery cells which is in the discharge sequence.

11. The method of claim 10, wherein the at least two battery cells are at least two groups of the battery cells, each group of the battery cells configured for operation of the charge sequence and the discharge sequence together.

12. The method of claim 11, wherein the group of battery cells are interconnected in parallel.

13. The method of claim 1, wherein the battery cell has a lithium-ion battery chemistry.

14. The method of claim 1, wherein the battery cell is a battery backup unit of an uninterruptable power supply.

15. The method of claim 1, wherein the battery cell temperature is determined by reading a data register of the battery cell.

16. The method of claim 1, wherein the charge level of the battery cell is determined by reading a data register of the battery cell.

17. A battery cell temperature maintenance system, comprising:
at least one battery cell
a controller
a discharging circuit;
a charging circuit; and
an energy reservoir;
the battery cell coupled to the controller, the discharging circuit and the charging circuit, whereby the battery cell may be charged and discharged under the control and feedback of the controller;
the discharging circuit and the charging circuit coupled to the energy reservoir to deliver energy from the discharging circuit to the energy reservoir and to receive energy from the energy reservoir to energize the charging circuit to charge the battery cell;
the controller operable to determine a battery cell temperature of the battery cell and a charge level of the battery cell.

18. The system of claim 17, wherein the battery cell temperature is provided in a data register of the battery cell, the data register readable by the controller.

19. The system of claim 17, wherein the charge level of the battery cell is provided in a data register of the battery cell, the data register readable by the controller.

20. The system of claim 17, further including a second battery cell temperature maintenance system according to claim 17, wherein the second battery maintenance system is configured to receive electric power into a second charge circuit from the discharge circuit; and the second battery system is configured to deliver electric power from a second discharge circuit to the charge circuit.
